(19) United States
(12) Patent Application Publication
(10) Pub. No.: US 2021/0196057 A1
(43) Pub. Date: Jul. 1, 2021

(54) Quickly Foldable Crib Frame

(71) Applicant: ANHUI COOLBABY SCIENCE & TECHNOLOGY DEVELOPMENT CORPORATION., Lu'an (CN)

(72) Inventors: Yingnian ZHANG, Lu'an (CN); Jianwei ZHAO, Lu'an (CN); Hongbing LIU, Lu'an (CN)

(73) Assignee: ANHUI COOLBABY SCIENCE & TECHNOLOGY DEVELOPMENT CORPORATION., Lu'an (CN)

(21) Appl. No.: 17/254,869

(22) PCT Filed: Jun. 18, 2020
(86) PCT No.: PCT/CN2020/096870

§ 371 Date: Feb. 4, 2021

(30) Foreign Application Priority Data
Jul. 4, 2019 (CN) 201910598555.3

(51) Int. Cl. A47D 9/00; F16B 7/10

(52) U.S. Cl. CPC A47D 9/005; F16B 7/105

(57) ABSTRACT

A quickly foldable crib frame relates to the field of cribs and includes a first U-shaped surrounding frame, a second U-shaped surrounding frame, upper vertical rods, and lower vertical rods. Both two free ends of the first U-shaped surrounding frame and two free ends of the second U-shaped surrounding frame are rotatably connected to first ends of the upper vertical rods. second ends of the upper vertical rods are slidably fitted in the lower vertical rods in length directions of the lower vertical rods. After the quickly foldable crib frame is folded, the quickly foldable crib frame takes up less space and is convenient to be moved.

### CROSS-REFERENCE TO THE RELATED APPLICATIONS

This application is the national stage entry of International Application No. PCT/CN2020/096870, filed on Jun. 18, 2020, which is based upon and claims priority to Chinese Patent Application No. 201910598555.3, filed on Jul. 4, 2019, the entire contents of which are incorporated herein by reference.

### TECHNICAL FIELD

The present disclosure relates to the technical field of cribs (or baby beds), and in particular to a quickly foldable crib frame.

### BACKGROUND

With the development of technology, cribs come in various styles, and their functions and prices also vary greatly. A current crib mainly comprises a bed frame and a bed enclosure, wherein the bed frame is configured to support the bed enclosure, and a baby can rest within the range of the bed enclosure.

The inventors have found in researches that the conventional cribs have at least the following shortcomings:

The bed frame and the bed surrounding frame cannot be folded and therefore occupy large space and are carried and moved inconveniently.

### SUMMARY

In order to solve the drawbacks of the prior art technical solutions, the present disclosure provides a quickly foldable crib frame.

In a first aspect, the present disclosure provides a quickly foldable crib frame, comprising: a first U-shaped surrounding frame and a second U-shaped surrounding frame, wherein first surrounding frame connectors and second surrounding frame connectors integrally formed are arranged at tail ends on both sides of the first U-shaped surrounding frame and the second U-shaped surrounding frame, respectively, the first surrounding frame connector and the second surrounding frame connector on each of both sides are rotatably riveted to an upper vertical rod connector, respectively, wherein the upper vertical rod connector is fixedly sleeved on a top end of an upper vertical rod, a bottom end of the upper vertical rod is slidably inserted in an inner cavity of a lower vertical rod, a bottom end of the lower vertical rod is fixedly inserted in a rotating base, one end of a first bottom horizontal brace rod and one end of a second bottom horizontal brace rod are rotatably riveted to the two, front and rear, sides of the rotating base, respectively, one end of a first bottom horizontal brace linkage and one end of a second bottom horizontal brace linkage are rotatably riveted to inner walls of the first bottom horizontal brace rod and the second bottom horizontal brace rod, respectively, a sliding sleeve is slidably sleeved on the lower vertical rod, and both the other end of the first bottom horizontal brace linkage and the other end of the second bottom horizontal brace linkage are rotatably riveted to the sliding sleeve.

Optionally, the quickly foldable crib frame comprises a riveting pin and a plug-in lock block, wherein both the first surrounding frame connector and the second surrounding frame connector are rotatably connected to the upper vertical rod connector by means of the riveting pin, and the plug-in lock block is separably fitted to the riveting pin, so as to be switched between a first state and a second state;

in the first state, the plug-in lock block locks the riveting pin such that the first surrounding frame connector, the second surrounding frame connector, and the upper vertical rod connector are fixed relative to one another;

in the second state, the plug-in lock block is separated from the riveting pin such that the first surrounding frame connector and the second surrounding frame connector are rotatable relative to the upper vertical rod connector.

Optionally, the quickly foldable crib frame further comprises a first locking lug, wherein the first locking lug is arranged at the top end of the upper vertical rod, the first locking lug has a guiding space through which one end of the plug-in lock block passes, and the plug-in lock block is engaged with the first locking lug and thus locked by the first locking lug in the first state. Optionally, a side wall of the upper vertical rod is provided with an elastic locking protrusion, a side wall of the lower vertical rod is provided with a locking hole communicating with the inner cavity of the lower vertical rod, and the elastic locking protrusion can be locked by the locking hole, so as to be switched between a third state and a fourth state;

in the third state, the elastic locking protrusion is fitted into (cooperates with) the locking hole such that the upper vertical rod is fixed relative to the lower vertical rod;

in the fourth state, the elastic locking protrusion is disengaged from the locking hole such that the upper vertical rod is slidable in the inner cavity of the lower vertical rod.

Optionally, a plurality of locking holes are provided, the plurality of locking holes are arranged spaced apart from one another in a length direction of the lower vertical rod, and the elastic locking protrusion is configured to be fitted into the different locking holes to change a length of extension of the upper vertical rod from the inner cavity of the lower vertical rod.

Optionally, the quickly foldable crib frame further comprises a sliding sleeve connecting tube, a sliding sleeve locking member, and a rotating pin, wherein the sliding sleeve connecting tube has an end connected to the sliding sleeve, and the sliding sleeve locking member is slidably inserted in the sliding sleeve connecting tube so that one end of the sliding sleeve locking member can extend from the sliding sleeve connecting tube and pass through the sliding sleeve to abut against the lower vertical rod;

the sliding sleeve connecting tube is provided with a through hole, and the rotating pin passes through the through hole and abuts against the sliding sleeve locking member so that the sliding sleeve connecting tube and the sliding sleeve locking member are fixed relative to each other, whereby the sliding sleeve is fixed to the lower vertical rod.

Optionally, two lower vertical rods are provided, the two lower vertical rods are arranged spaced apart from each other, and the two ends of the sliding sleeve connecting tube are connected to the sliding sleeves sleeved on the two lower vertical rods, respectively;

two sliding sleeve locking members are provided, the two sliding sleeve locking members are arranged spaced apart from each other in the sliding sleeve connecting tube, one of the sliding sleeve locking members abuts against one of the lower vertical rods, and the other one of the sliding sleeve locking members abuts against the other one of the lower vertical rods.

Optionally, an outer wall of the sliding sleeve connecting tube is provided with sliding slots communicating with an inner cavity of the sliding sleeve connecting tube, each of the two sliding sleeve locking members is provided with a sliding protrusion at its end close to the sliding slot, and the two sliding protrusions are slidably engaged in the sliding slots so that the two sliding sleeve locking members are moved close to or away from each other.

Optionally, the quickly foldable crib frame further comprises a sliding sleeve unlocking member, wherein the sliding sleeve unlocking member is rotatably sleeved on the sliding sleeve connecting tube, the sliding sleeve unlocking member is provided with a first slot segment and a second slot segment, the first slot segment and the second slot segment communicate with each other to form a trapezoidal slot, and the first slot segment and the second slot segment are fitted with the two sliding protrusions at different time so that the two sliding sleeve locking members are moved close to or away from each other;

the sliding sleeve unlocking member is configured to drive the two sliding protrusions to slide from the first slot segment to the second slot segment or from the second slot segment to the first slot segment when rotating relative to the sliding sleeve connecting tube.

Optionally, an integrally formed second locking lug is arranged on an inner wall of the top end of the lower vertical rod, an integrally formed unlocking insert is arranged on a side wall of the sliding sleeve, and the unlocking insert is separably fitted to the second locking lug.

Optionally, the rotating bases on both sides are connected by a bottom linkage.

Optionally, universal wheels are rotatably mounted both at an end of the first bottom horizontal brace rod away from the rotating base and at an end of the second bottom horizontal brace rod away from the rotating base.

In a second aspect, the present disclosure provides a quickly foldable crib frame, comprising a first U-shaped surrounding frame, a second U-shaped surrounding frame, upper vertical rods, and lower vertical rods;

both the two free ends of the first U-shaped surrounding frame and the two free ends of the second U-shaped surrounding frame are rotatably connected to one ends of the upper vertical rods, and the other ends of the upper vertical rods are slidably fitted in the lower vertical rods in length directions of the lower vertical rods.

Optionally, the quickly foldable crib frame further comprises a first surrounding frame connector, a second surrounding frame connector, an upper vertical rod connector, and a riveting pin, wherein the first surrounding frame connector is mounted at the free end of the first U-shaped surrounding frame, the second surrounding frame connector is mounted at the free end of the second U-shaped surrounding frame, the upper vertical rod connector is mounted at an upper end of the upper vertical rod, and the first surrounding frame connector and the second surrounding frame connector are rotatably connected to the upper vertical rod connector by means of the riveting pin.

Optionally, the lower vertical rod is in a tube structure, and the upper vertical rod is slidably inserted into the lower vertical rod.

Optionally, the quickly foldable crib frame further comprises a rotating base, a first bottom horizontal brace rod, and a second bottom horizontal brace rod, wherein the rotating base is connected to a lower end of the lower vertical rod, and the first bottom horizontal brace rod and the second bottom horizontal brace rod are rotatably connected to the two sides of the rotating base, respectively.

Optionally, the quickly foldable crib frame further comprises a sliding sleeve, a first bottom horizontal brace linkage, and a second bottom horizontal brace linkage, wherein the sliding sleeve is slidably sleeved on the lower vertical rod, the first bottom horizontal brace linkage has one end rotatably connected to the sliding sleeve and the other end rotatably connected to the first bottom horizontal brace rod, and the second bottom horizontal brace linkage has one end rotatably connected to the sliding sleeve and the other end rotatably connected to the second bottom horizontal brace rod.

Optionally, the quickly foldable crib frame further comprises a sliding sleeve connecting tube, a sliding sleeve locking member, and a rotating pin, wherein the sliding sleeve connecting tube has an end connected to the sliding sleeve, and the sliding sleeve locking member is slidably inserted in the sliding sleeve connecting tube so that one end of the sliding sleeve locking member can extend from the sliding sleeve connecting tube and pass through the sliding sleeve, so as to abut against the lower vertical rod;
the sliding sleeve connecting tube is provided with a through hole, and the rotating pin passes through the through hole and abuts against the sliding sleeve locking member so that the sliding sleeve connecting tube and the sliding sleeve locking member are fixed relative to each other, whereby the sliding sleeve is fixed to the lower vertical rod.

Optionally, two lower vertical rods are provided, the two lower vertical rods are arranged spaced apart from each other, and the two ends of the sliding sleeve connecting tube are connected to the sliding sleeves sleeved on the two lower vertical rods, respectively;

two sliding sleeve locking members are provided, the two sliding sleeve locking members are arranged spaced apart from each other in the sliding sleeve connecting tube, one of the sliding sleeve locking members abuts against one of the lower vertical rods, and the other one of the sliding sleeve locking members abuts against the other one of the lower vertical rods.

Optionally, an outer wall of the sliding sleeve connecting tube is provided with a sliding slot communicating with an inner cavity of the sliding sleeve connecting tube, each of the two sliding sleeve locking members is provided with a sliding protrusion at its end close to the sliding slot, and the two sliding protrusions are slidably engaged in the sliding slots;

the quickly foldable crib frame further comprises a sliding sleeve unlocking member, wherein the sliding sleeve unlocking member is rotatably sleeved on the sliding sleeve connecting tube, the sliding sleeve unlocking member is provided with a first slot segment and a second slot segment, the first slot segment and the second slot segment communicate with each other to form a trapezoidal slot, and the first slot segment and the second slot segment are fitted with the two sliding protrusions at different time so that the two sliding sleeve locking members are moved close to or away from each other;

the sliding sleeve unlocking member is configured to drive the two sliding protrusions to slide from the first slot segment to the second slot segment or from the second slot segment to the first slot segment when rotating relative to the sliding sleeve connecting tube.

The embodiments of the present disclosure include, for example, the following advantageous effects over the prior art.

An embodiment of the present disclosure provides a quickly foldable crib frame. The upper vertical rods are slid and retracted into the lower vertical rods, so that the overall height of the crib frame is compressed. The sliding sleeves are slid upward along the lower vertical rods so that the first bottom horizontal brace rods, the second bottom horizontal brace rods, and the first U-shaped surrounding frame and the second U-shaped surrounding frame are driven to be folded coordinately and efficiently. Moreover, the crib frame has a reasonable structural design, occupying a smaller area when folded, which meets the user's intention to save space.

An embodiment of the present disclosure further provides a quickly foldable crib frame. When the first U-shaped surrounding frame and the second U-shaped surrounding frame are rotated relative to the upper vertical rods, the first U-shaped surrounding frame and the second U-shaped surrounding frame can be folded to occupy less space. Furthermore, when the upper vertical rods are moved relative to the lower vertical rods in the length directions of the lower vertical rods, the upper vertical rods and the lower vertical rods can be overlapped with each other, so that less space is occupied by the upper vertical rods and the lower vertical rods as a whole. In this way, the quickly foldable crib frame occupies less space and can be carried and moved conveniently after it is folded.

### BRIEF DESCRIPTION OF THE DRAWINGS

In order to more clearly illustrate technical solutions of embodiments of the present disclosure, drawings required for use in the embodiments will be described briefly below. It is to be understood that the drawings below are merely illustrative of some embodiments of the present disclosure, and therefore should not be considered as limiting its scope. It will be understood by those of ordinary skill in the art that other relevant drawings can also be obtained from these drawings without any inventive effort.

FIG. 1 is a schematic structural view of a quickly foldable crib frame according to an embodiment of the present disclosure;

FIG. 2 is a schematic view showing disassembly of a surrounding frame assembly of a quickly foldable crib frame according to an embodiment of the present disclosure;

FIG. 3 is a schematic structural view of a plug-in lock block fitted to a first locking lug according to an embodiment of the present disclosure;

FIG. 4 is a schematic sectional view of a quickly foldable crib frame according to an embodiment of the present disclosure when viewed in a front direction;

FIG. 5 is a schematic structural view of a sliding protrusion fitted to a sliding slot according to an embodiment of the present disclosure;

FIG. 6 is a schematic view showing a first laterally folded state of a quickly foldable crib frame according to an embodiment of the present disclosure;

FIG. 7 is a schematic view showing a second laterally folded state of a quickly foldable crib frame according to an embodiment of the present disclosure; and

FIG. 8 is a schematic view showing a third laterally folded state of a quickly foldable crib frame according to an embodiment of the present disclosure.

Reference Signs: 1—first U-shaped surrounding frame; 2—second U-shaped surrounding frame; 3—first surrounding frame connector; 4—second surrounding frame connector; 5—upper vertical rod connector; 6—upper vertical rod; 60—elastic locking protrusion; 61—first locking lug; 611—guiding space; 7—lower vertical rod; 70—locking hole; 71—second locking lug; 8—rotating base; 9—first bottom horizontal brace rod; 10—second bottom horizontal brace linkage; 11—first bottom horizontal brace linkage; 12—second bottom horizontal brace rod; 13—sliding sleeve; 130—unlocking insert; 14—plug-in lock block; 15—sliding sleeve connecting tube; 151—sliding slot; 16—sliding sleeve unlocking member; 161—first slot segment; 162—second slot segment; 17—sliding sleeve locking member; 170—through hole; 171—sliding protrusion; 18—rotating pin; 19—bottom linkage; 20—universal wheel; 21—riveting pin.

### DETAILED DESCRIPTION OF THE EMBODIMENTS

In order to further clarify the objects, technical solutions, and advantages of the embodiments of the present disclosure, the technical solutions of the embodiments of the present disclosure will be described below clearly and completely with reference to the drawings of the embodiments of the present disclosure. It is apparent that the embodiments to be described are some, but not all of the embodiments of the present disclosure. Generally, the components of the embodiments of the present disclosure, as described and illustrated in the drawings herein, may be arranged and designed in a wide variety of different configurations.

Thus, the following detailed description of the embodiments of the present disclosure, as represented in the drawings, is not intended to limit the scope of the present disclosure as claimed, but is merely representative of selected embodiments of the present disclosure. All the other embodiments obtained by those of ordinary skill in the art in light of the embodiments of the present disclosure without inventive efforts will fall within the scope of the present disclosure as claimed.

It should be noted that similar reference signs and letters refer to similar items in the following drawings, and thus once a certain item is defined in one figure, it may not be further defined or explained in the following figures.

In the description of the present disclosure, it should be noted that orientation or positional relationships indicated by the terms such as “center”, “up”, “down”, “left”, “right”, “vertical”, “horizontal”, “inside”, and “outside”, if present, are the orientation or positional relationships shown based on the drawings, or the orientation or positional relationships in which the inventive product is conventionally placed when in use, and these terms are intended only to facilitate the description of the present disclosure and simplify the description, but not intended to indicate or imply that the referred devices or elements must be in a particular orientation, or constructed or operated in the particular orientation, and therefore should not be construed as limiting the present disclosure.

In addition, terms such as “first”, “second”, and “third”, if present, are used for distinguishing description only, and should not be understood as an indication or implication of relative importance.

In addition, the term such as “horizontal”, “vertical”, “overhanging”, or the like, if present, means that a component may be slightly inclined, rather than being required to be absolutely horizontal or overhanging. For example, by the term “horizontal”, it is simply meant that its direction is more horizontal than the term “vertical”, and it is not meant that the structure must be completely horizontal, but it is meant that the structure may be slightly inclined.

In the description of the present disclosure, it should also be noted that terms such as “arranged”, “mounted”, “coupled”, and “connected”, if present, should be understood broadly, unless otherwise expressly specified or defined. For example, connection may be fixed connection or detachable connection or integral connection, may be mechanical connection or electric connection, or may be direct coupling or indirect coupling via an intermediate medium or internal communication between two elements. The specific meanings of the above-mentioned terms in the present disclosure can be understood by those of ordinary skill in the art according to specific situations.

It should be noted that the features in the embodiments of the present disclosure can be combined with each other without conflict.

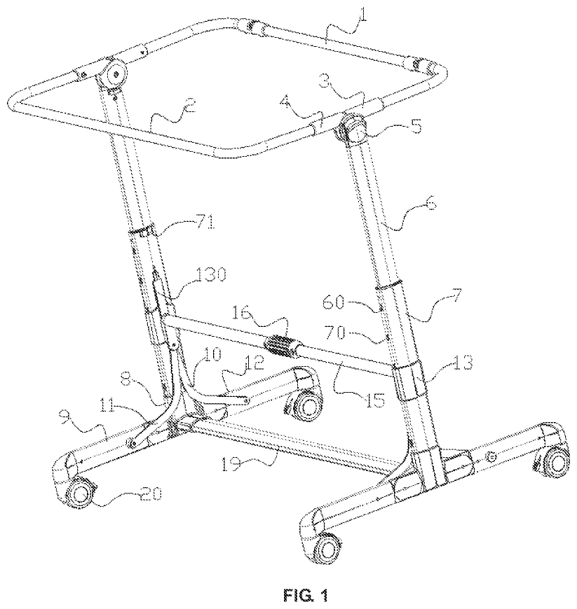

Referring to FIG. 1, an embodiment of the present disclosure provides a quickly foldable crib frame, comprising a first U-shaped surrounding frame 1, a second U-shaped surrounding frame 2, upper vertical rods 6, and lower vertical rods 7. Both the two free ends of the first U-shaped surrounding frame 1 and the two free ends of the second U-shaped surrounding frame 2 are rotatably connected to one ends of the upper vertical rods 6, and the other ends of the upper vertical rods 6 are slidably fitted into the lower vertical rods 7 in the length directions of the lower vertical rods 7.

It can be understood that when the first U-shaped surrounding frame 1 and the second U-shaped surrounding frame 2 are rotated relative to the upper vertical rods 6, the first U-shaped surrounding frame 1 and the second U-shaped surrounding frame 2 can be folded to occupy reduced space. Furthermore, when the upper vertical rods 6 are moved relative to the lower vertical rods 7 in the length directions of the lower vertical rods 7, the upper vertical rods 6 and the lower vertical rods 7 can be overlapped with each other, so that less space is occupied by the upper vertical rods 6 and the lower vertical rods 7 as a whole. In this way, the quickly foldable crib frame occupies less space and can be carried and moved conveniently after it is folded. Referring to FIGS. 1 to 3, in this embodiment, the quickly foldable crib frame further comprises first surrounding frame connectors 3, second surrounding frame connectors 4, upper vertical rod connectors 5, and riveting pins 21. The first surrounding frame connector 3 is mounted at the free end of the first U-shaped surrounding frame 1. The second surrounding frame connector 4 is mounted at the free end of the second U-shaped surrounding frame 2. The upper vertical rod connector 5 is mounted at the upper end of the upper vertical rod 6. The first surrounding frame connector 3 and the second surrounding frame connector 4 are rotatably connected to the upper vertical rod connector 5 by means of the riveting pin 21.

It should be noted that, in this embodiment, each of the first surrounding frame connector 3, the second surrounding frame connector 4, and the upper vertical rod connector 5 is in a sleeve structure. The first surrounding frame connector 3 is detachably sleeved on the free end of the first U-shaped surrounding frame 1. The second surrounding frame connector 4 is detachably sleeved on the free end of the second U-shaped surrounding frame 2. The upper vertical rod connector 5 is detachably sleeved on the upper vertical rod 6. This facilitates the mounting and replacement of the first surrounding frame connector 3, the second surrounding frame connector 4, and the upper vertical rod connector 5.

It should be noted that, in this embodiment, the riveting pins 21 pass simultaneously through the first surrounding frame connectors 3, the second surrounding frame connectors 4, and the upper vertical rod connectors 5. In this way, the first surrounding frame connectors 3 and the second surrounding frame connectors 4 can be rotated relative to the upper vertical rod connectors 5 to drive the first U-shaped surrounding frame 1 and the second U-shaped surrounding frame 2 to rotate, thereby achieving the folding function of the first U-shaped surrounding frame 1 and the second U-shaped surrounding frame 2, so as to reduce the amount of space occupied by the first U-shaped surrounding frame 1 and the second U-shaped surrounding frame 2.

Referring to FIGS. 1 to 3, in this embodiment, the quickly foldable crib frame further comprises a plug-in lock blocks 14. The plug-in lock block 14 is separably fitted to the riveting pin 21, so as to be switched between a first state and a second state.

Specifically, in the first state, the plug-in lock blocks 14 lock the riveting pins 21. In this way, the first surrounding frame connectors 3 and the second surrounding frame connectors 4 are not rotatable relative to the upper vertical rod connectors 5. At this time, an area enclosed by the first U-shaped surrounding frame 1 and the second U-shaped surrounding frame 2 allows a baby to take activity or rest therein.

Furthermore, in the second state, the plug-in lock blocks 14 are separated from the riveting pins 21 such that the first surrounding frame connectors 3 and the second surrounding frame connectors 4 are rotatable relative to the upper vertical rod connectors 5. At this time, the first U-shaped surrounding frame 1 and the second U-shaped surrounding frame 2 can be folded to occupy a reduced amount of space.

It should be noted that the quickly foldable crib frame further comprises a first locking lugs 61. The first locking lug 61 is arranged at the top end of the upper vertical rod 6. The first locking lug 61 has a guiding space 611, through which one end of the plug-in lock block 14 passes. In this way, when the plug-in lock block 14 is separated from the riveting pin 21, the plug-in lock block 14 is movable along the guiding space 611, which has the effect of guiding the direction of movement of the plug-in lock block 14 and facilitates the disengagement of the plug-in lock block 14 from the riveting pin 21.

Furthermore, in the first state described above, the plug-in lock blocks 14 are engaged with the first locking lugs 61, and the plug-in lock blocks 14 can be locked by the first locking lugs 61, so that the first U-shaped surrounding frame 1, the second U-shaped surrounding frame 2, and the upper vertical rods 6 are locked.

With reference to FIG. 1, in this embodiment, the lower vertical rod 7 is in a tube structure, and the upper vertical rod 6 is slidably inserted into the lower vertical rod 7. In this way, the upper vertical rod 6 can be conveniently received in the inner cavity of the lower vertical rod 7, which facilitates storage, carrying, and movement thereof.

It should be noted that, in other embodiments, the upper vertical rod 6 may be in a tube structure, and the upper vertical rod 6 is slidably sleeved on the outside of the lower vertical rod 7. Alternatively, in other embodiments, a sliding fitting structure consisting of a sliding slot and a sliding block may be used between the upper vertical rod 6 and the lower vertical rod 7 to achieve the stretching and contracting functions.

Referring to FIG. 1, in this embodiment, a side wall of the upper vertical rod 6 is provided with an elastic locking protrusion 60. A side wall of the lower vertical rod 7 is provided with a locking hole 70 communicating with the inner cavity of the lower vertical rod 7. The elastic locking protrusion 60 can be fitted into the locking hole 70 in locking manner, so as to be switched between a third state and a fourth state.

Specifically, in the third state, the elastic locking protrusions 60 are fitted into the locking holes 70 such that the upper vertical rods 6 are fixed relative to the lower vertical rods 7. At this time, the upper vertical rods 6 and the lower vertical rods 7 serve as a support, which can support the first U-shaped surrounding frame 1, the second U-shaped surrounding frame 2, and a baby located in the area enclosed by the first U-shaped surrounding frame 1 and the second U-shaped surrounding frame 2.

In the fourth state, the elastic locking protrusion 60 is disengaged from the locking hole 70 such that the upper vertical rod 6 is slidable in the inner cavity of the lower vertical rod 7. At this time, the upper vertical rod 6 can be retracted into the inner cavity of the lower vertical rod 7, and the elastic locking protrusion 60 is in a compressed state.

It can be understood that once the elastic locking protrusion 60 is moved to a region corresponding to the locking hole 70, the elastic locking protrusion 60 can be fitted into the locking hole 70 under the elastic action. In other words, the switching from the fourth state to the third state is completed. Similarly, when the elastic locking protrusion 60 is pressed to be disengaged from the locking hole 70 and then the upper vertical rod 6 is moved so that the upper vertical rod 6 is retracted into the inner cavity of the lower vertical rod 7, such that the switching from the third state to the fourth state is completed.

Referring to FIG. 1, in this embodiment, a plurality of locking holes 70 are provided, and the plurality of locking holes 70 are arranged spaced apart from one another in the length direction of the lower vertical rod 7. When the elastic locking protrusion 60 is fitted into a different locking holes 70, the upper vertical rod 6 extends from the inner cavity of the lower vertical rod 7 at a different length. In this way, in actual use, the user may fit the elastic locking protrusions 60 into the locking holes 70 at different heights according to the actual situation, so as to change the actual height of the first U-shaped surrounding frame 1 and the second U-shaped surrounding frame 2.

Referring to FIG. 1, in this embodiment, the quickly foldable crib frame further comprises rotating bases 8, first bottom horizontal brace rods 9, and second bottom horizontal brace rods 12. The rotating base 8 is connected to the lower end of the lower vertical rod 7. The first bottom horizontal brace rod 9 and the second bottom horizontal brace rod 12 are rotatably connected to the two sides of the rotating base 8, respectively.

It can be understood that when the first bottom horizontal brace rod 9 and the second bottom horizontal brace rod 12 are rotated relative to the rotating base 8 in a direction close to the lower vertical rod 7, less space can be occupied by the first bottom horizontal brace rod 9 and the second bottom horizontal brace rod 12 as a whole. When the first bottom horizontal brace rod 9 and the second bottom horizontal brace rod 12 are rotated relative to the rotating base 8 in a direction away from the lower vertical rod 7, at this time, the first bottom horizontal brace rod 9 and the second bottom horizontal brace rod 12 can achieve the function of supporting the lower vertical rod 7. At this time, the length direction of the first bottom horizontal brace rod 9 and the length direction of the second bottom horizontal brace rod 12 are in the same direction and perpendicular to the length direction of the lower vertical rod 7, which can effectively improve the stability.

Furthermore, in this embodiment, universal wheels 20 are mounted both at an end of the first bottom horizontal brace rod 9 away from the rotating base 8 and at an end of the second bottom horizontal brace rod 12 away from the rotating base 8. In this way, the quickly foldable crib frame can be conveniently moved as a whole.

Referring to FIGS. 1, 4, and 5, in this embodiment, the quickly foldable crib frame further comprises sliding sleeves 13, first bottom horizontal brace linkages 11, and second bottom horizontal brace linkages 10. The sliding sleeve 13 is slidably sleeved on the lower vertical rod 7. One end of the first bottom horizontal brace linkage 11 is rotatably connected to the sliding sleeve 13, and the other end of the first bottom horizontal brace linkage 11 is rotatably connected to the first bottom horizontal brace rod 9. One end of the second bottom horizontal brace linkage 10 is rotatably connected to the sliding sleeve 13, and the other end of the second bottom horizontal brace linkage 10 is rotatably connected to the second bottom horizontal brace rod 12. In this way, when the sliding sleeve 13 is sliding relative to the lower vertical rod 7, the first bottom horizontal brace rod 9 and the second bottom horizontal brace rod 12 can be simultaneously driven to rotate relative to the rotating base 8, so that the first bottom horizontal brace rod 9 and the second bottom horizontal brace rod 12 can be conveniently folded or unfolded.

Referring to FIGS. 1, 4, and 5, in this embodiment, the quickly foldable crib frame further comprises a sliding sleeve connecting tube 15 and a sliding sleeve locking member 17. The sliding sleeve connecting tube 15 has an end connected to the sliding sleeve 13. The sliding sleeve locking member 17 is slidably arranged in the sliding sleeve connecting tube 15. It should be noted that, in this embodiment, the sliding sleeve locking member 17 is in a rod-shaped structure, and one end of the sliding sleeve locking member 17 can extend from the sliding sleeve connecting tube 15 and pass through the sliding sleeve 13 and finally abut against the lower vertical rod 7.

Referring to FIGS. 1, 4, and 5, in this embodiment, the quickly foldable crib frame further comprises rotating pins 18. The sliding sleeve connecting tube 15 is further provided with through holes 170. The rotating pin 18 passes through the through hole 170 and abuts against the sliding sleeve locking member 17. In this way, the sliding sleeve connecting tube 15 and the sliding sleeve locking member 17 can be fixed relative to each other, so that the sliding sleeve 13 can be fixed to the lower vertical rod 7.

In this way, in the normal use state, the sliding sleeve 13 will not slide relative to the lower vertical rod 7, so that a good supporting effect can be achieved.

It can be understood that when the rotating pin 18 is removed, the sliding sleeve locking member 17 is movable in a direction away from the lower vertical rod 7, so that the sliding sleeve locking member 17 can be disengaged from the sliding sleeve 13. In this case, the sliding sleeve 13 is slidable relative to the lower vertical rod 7 for subsequent folding operation.

With reference to FIG. 1, in this embodiment, there are two lower vertical rods 7. The two lower vertical rods 7 are arranged spaced apart from each other. The two ends of the sliding sleeve connecting tube 15 are connected to the sliding sleeves 13 sleeved on the two lower vertical rods 7, respectively. In this way, the stability between the two lower vertical rods 7 can be enhanced, so as to improve the supporting performance.

Correspondingly, in this embodiment, the quickly foldable crib frame further comprises a bottom linkage 19. There are, likewise, two rotating bases 8. The two rotating bases 8 are mounted to the two lower vertical rods 7, respectively. The two ends of the bottom linkage 19 are connected to the two rotating bases 8, respectively. In this way, the stability between the two rotating bases 8 can be improved.

In this embodiment, there are two sliding sleeve locking members 17. The two sliding sleeve locking members 17 are arranged spaced apart from each other in the sliding sleeve connecting tube 15, wherein one of the sliding sleeve locking members 17 abuts against one of the lower vertical rods 7, and the other sliding sleeve locking member 17 abuts against the other lower vertical rod 7.

It can be understood that the gap between the two sliding sleeve locking members 17 provides space for the movements of the two sliding sleeve locking members 17 in the axial direction of the sliding sleeve connecting tube 15.

Furthermore, the two sliding sleeve locking members 17 allow the sliding sleeves 13 on the two lower vertical rods 7 to be fixed to the corresponding lower vertical rods 7, respectively. It can be understood that when the two sliding sleeve locking members 17 are moved close to each other, the two sliding sleeve locking members 17 are disengaged from the corresponding lower vertical rods 7, respectively, so that the sliding sleeves 13 on the two lower vertical rods 7 are slidable to allow the subsequent folding operation.

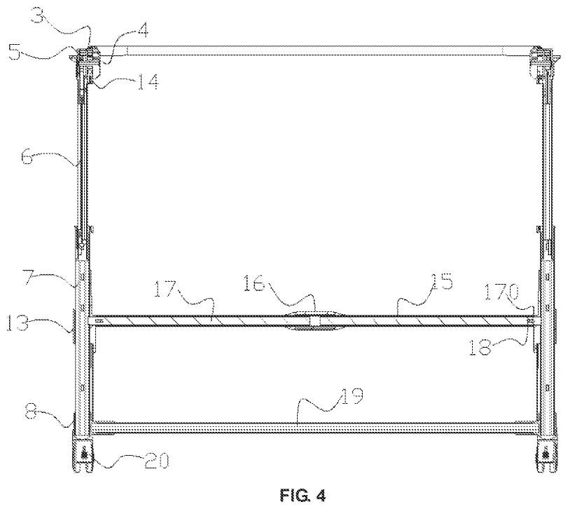

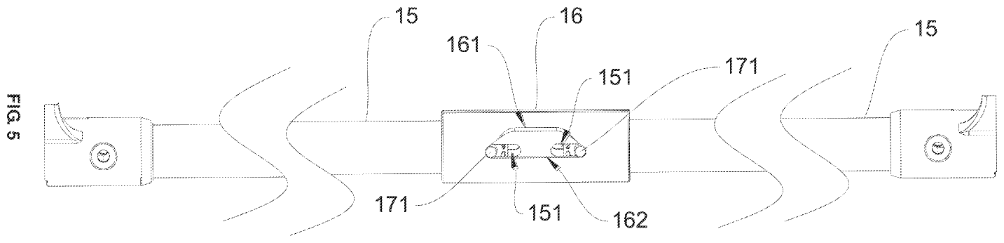

With reference to FIGS. 4 and 5, the outer wall of the sliding sleeve connecting tube 15 is provided with sliding slots 151 communicating with the inner cavity of the sliding sleeve connecting tube 15. Each of the two sliding sleeve locking members 17 is provided with a sliding protrusion 171 at its end close to the sliding slot 151. The two sliding protrusions 171 are slidably engaged in the sliding slots 151, so that the two sliding sleeve locking members 17 are movable close to or away from each other.

It can be understood that the sliding protrusions 171 can effectively serve as guiding when sliding in the sliding slots 151.

Referring to FIG. 5, in this embodiment, there are two sliding slots 151. The two sliding slots 151 are arranged spaced apart from each other. The two sliding protrusions 171 are engaged in the two sliding slots 151, respectively. The two sliding protrusions 171 will not interfere with each other during sliding, whereby smooth sliding can be ensured.

Referring to FIGS. 1, 4, and 5, in this embodiment, the quickly foldable crib frame further comprises a sliding sleeve unlocking member 16. The sliding sleeve unlocking member 16 is rotatably sleeved on the sliding sleeve connecting tube 15. The sliding sleeve unlocking member 16 is provided with a first slot segment 161 and a second slot segment 162. The first slot segment 161 and the second slot segment 162 communicate with each other to form a trapezoidal slot. The first slot segment 161 and the second slot segment 162 are fitted with the two sliding protrusions 171 at different time, so that the two sliding sleeve locking members 17 are moved close to or away from each other.

In this embodiment, when the sliding sleeve unlocking member 16 is rotated relative to the sliding sleeve connecting tube 15, the two sliding protrusions 171 may be driven to slide from the second slot segment 162 to the first slot segment 161, so that the two sliding sleeve locking members 17 are moved close to each other, and the two sliding sleeve locking members 17 are separated from the corresponding lower vertical rods 7, respectively. At this time, the sliding sleeves 13 are slidable relative to the lower vertical rods 7, so as to achieve the subsequent folding operation.

Furthermore, when the sliding sleeve unlocking member 16 is rotated relative to the sliding sleeve connecting tube 15, the two sliding protrusions 171 may also be driven to slide from the first slot segment 161 to the second slot segment 162, so that the two sliding sleeve locking members 17 are moved away from each other, and the two sliding sleeve locking members 17 pass through the corresponding sliding sleeves 13 and abut against the corresponding lower vertical rods 7, respectively. At this time, the sliding sleeves 13 are fixed relative to the lower vertical rods 7.

Referring to FIG. 1, an integrally formed second locking lug 71 is arranged on the inner wall of the top end of the lower vertical rod 7. An integrally formed unlocking insert 130 is arranged on the side wall of the sliding sleeve 13. The unlocking insert 130 is separably fitted to the second locking lug 71. During folding, the unlocking inserts 130 can be moved relative to the lower vertical rods 7 along with the sliding sleeves 13. When moved to the positions corresponding to the second locking lugs 71, the unlocking inserts 130 are fitted to the second locking lugs 71 to achieve a fixing function. In this way, after the folding operation is completed, the sliding sleeves 13 can be fixed relative to the lower vertical rods 7, so that the quickly foldable crib frame can be kept in the folded state and thus conveniently carried and moved.

In summary, referring to FIG. 1 and FIGS. 6 to 8. The quickly foldable crib frame is folded by the following process.

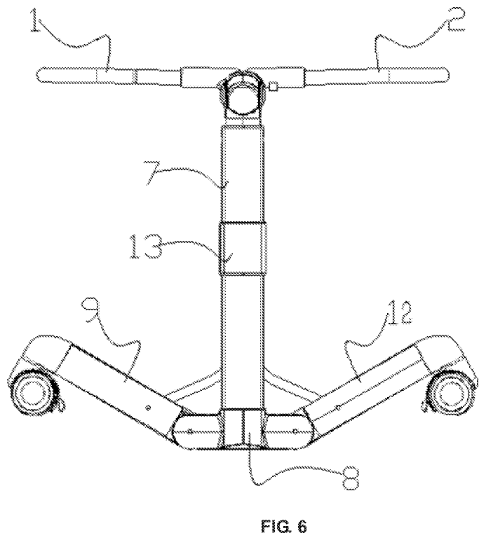

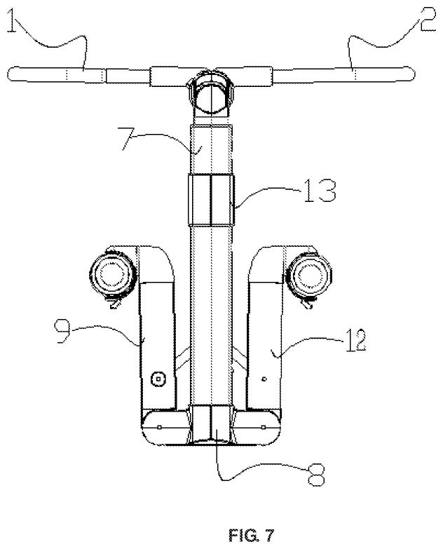

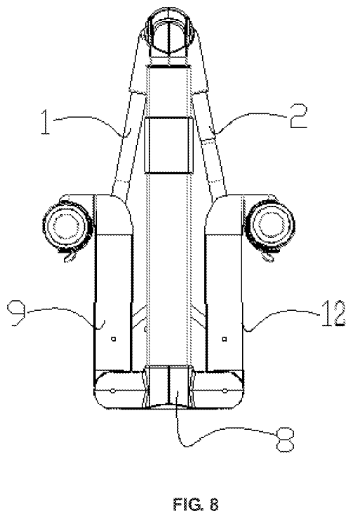

The elastic locking protrusions 60 are pressed so that the elastic locking protrusions 60 are disengaged from the locking holes 70, and the upper vertical rods 6 are slid downward and inserted into the lower vertical rods 7 to achieve overlapping. Then, the rotating pins 18 are adjusted so that the rotating pins 18 are separated from the sliding sleeve connecting tube 15, and then the sliding sleeve unlocking member 16 is rotated to drive the two sliding protrusions 171 to slide from the second slot segment 162 to the first slot segment 161, so that the two sliding sleeve locking members 17 are moved closed to each other, and the two sliding sleeve locking members 17 are separated from the corresponding lower vertical rods 7, respectively. Then, the two sliding sleeves 13 are respectively slid relative to the two lower vertical rods 7 to drive the corresponding first bottom horizontal brace rods 9 and second bottom horizontal brace rods 12 to rotate relative to the rotating bases 8, so as to achieve folding (as in the states shown in FIGS. 6 and 7). Then, the plug-in lock blocks 14 are adjusted so that the plug-in lock blocks 14 are separated from the riveting pins 21, and the first surrounding frame connectors 3 and the second surrounding frame connectors 4 are rotated relative to the upper vertical rod connectors 5, so as to achieve folding (as in the state shown in FIG. 8).

As shown in FIGS. 1 to 6, the present disclosure provides a quickly foldable crib frame, comprising: a first U-shaped surrounding frame 1 and a second U-shaped surrounding frame 2. First surrounding frame connectors 3 and second surrounding frame connectors 4 integrally formed are arranged at tail ends on both sides of the first U-shaped surrounding frame 1 and the second U-shaped surrounding frame 2, respectively. The first surrounding frame connector 3 and the second surrounding frame connector 4 on each of both sides are respectively rotatably riveted to an upper vertical rod connector 5, which is fixedly sleeved on a top end of an upper vertical rod 6. A bottom end of the upper vertical rod 6 is slidably inserted in an inner cavity of a lower vertical rod 7. A bottom end of the lower vertical rod 7 is fixedly inserted in a rotating base 8. One end of a first bottom horizontal brace rod 9 and one end of a second bottom horizontal brace rod 12 are rotatably riveted to the two, front and rear, sides of the rotating base 8, respectively.

One end of a first bottom horizontal brace linkage 11 and one end of a second bottom horizontal brace linkage 10 are rotatably riveted to inner walls of the first bottom horizontal brace rod 9 and the second bottom horizontal brace rod 12, respectively. A sliding sleeve 13 is slidably sleeved on the lower vertical rod 7. Both the other end of the first bottom horizontal brace linkage 11 and the other end of the second bottom horizontal brace linkage 10 are rotatably riveted to the sliding sleeve 13.

A plug-in lock block 14 is arranged in the inner riveting cavity among the first surrounding frame connector 3, the second surrounding frame connector 4, and the upper vertical rod connector 5. An integrally formed first locking lug 61 is arranged on the inner wall of the top end of the upper vertical rod 6. The bottom end of the plug-in lock block 14 is inserted in the first locking lug 61 to form a locking fitting assembly.

An elastic locking protrusion 60 is arranged on the side wall of the bottom end of the upper vertical rod 6. Several locking holes 70 are provided in the side wall of the lower vertical rod 7. The elastic locking protrusion 60 is inserted into one of the provided locking holes 70 to form a locking fitting assembly.

An integrally formed sliding sleeve connecting tube 15 is arranged perpendicularly on the side walls of the sliding sleeves 13. A sliding sleeve unlocking member 16 is sleeved on the middle position of the sliding sleeve connecting tube 15. Sliding sleeve locking members 17 are inserted into both sides of the inner cavity of the sliding sleeve connecting tube 15. The sliding sleeve locking members 17 on both sides are arranged spaced apart from each other, and one end of each of the sliding sleeve locking members 17 is provided with a through hole 170. The sliding sleeve connecting tube 15 is provided with a rotating pin 18 assembled in the through hole 170 for sliding adjustment. The one end of the sliding sleeve locking member 17 is arranged to abut against and thus be locked and assembled onto the side wall of the lower vertical rod 7. An integrally formed second locking lug 71 is arranged on the inner wall of the top end of the lower vertical rod 7. An integrally formed unlocking insert 130 is arranged on the side wall of the sliding sleeve 13. The second locking lug 71 is arranged such that the unlocking insert 130 is stably inserted therein.

The rotating bases 8 on both sides are connected by a bottom linkage 19. The bottom linkage 19 is arranged for stable supporting and connection.

A universal wheel 20 is rotatably mounted at the other end of each of the first bottom horizontal brace rods 9 and the second bottom horizontal brace rods 12. The universal wheels 20 are arranged to facilitate pushing of the crib frame.

The present disclosure is implemented as follows. During folding, the user unlocks the upper vertical rods 6 from the lower vertical rods 7 by pressing the elastic locking protrusions 60 into the locking holes 70, so that the upper vertical rods 6 are slid downward and inserted and retracted into the lower vertical rods 7. The sliding of the sliding sleeve locking members 17 is adjusted by rotating pins 18 to release the locking by abutment of the lower vertical rods 7 by the sliding sleeve locking members 17, so that the sliding sleeves 13 are slid upward along the lower vertical rods 7, whereby the sliding sleeves 13 drive, by means of the first bottom horizontal brace linkages 11 and the second bottom horizontal brace linkages 10, the first bottom horizontal brace rods 9 and the second bottom horizontal brace rods 12 to be folded upward along the rotating bases 8, respectively. The first bottom horizontal brace rods 9 and the second bottom horizontal brace rods 12 are completely folded until the first bottom horizontal brace rods 9 and the second bottom horizontal brace rods 12 are parallel to the lower vertical rods 7. While the sliding sleeves 13 are sliding upward, the unlocking inserts 130 arranged on the sliding sleeves 13 are inserted upward through the second locking lugs 71, and the plug-in lock blocks 14 inserted and locked in the first locking lugs 61 are pushed upward. Thus, the plug-in lock blocks 14 are moved upward in the inner riveting cavities among the first surrounding frame connectors 3, the second surrounding frame connectors 4, and the upper vertical rod connectors 5, so as to unlock the riveting pins, so that the first U-shaped surrounding frame 1 and the second U-shaped surrounding frame 2 are folded downward under the action of their own gravity, whereby the whole crib frame is folded. According to this technical solution, the upper vertical rods are slid and retracted into the lower vertical rods, so that the overall height of the crib frame is compressed. The sliding sleeves are slid upward along the lower vertical rods so that the first bottom horizontal brace rods, the second bottom horizontal brace rods, and the first U-shaped surrounding frame and the second U-shaped surrounding frame are driven to be folded and retracted coordinately and efficiently. Moreover, the crib frame has a reasonable structural design, occupying a smaller area when folded, which meets the user's intention to save space.

In some embodiments:

Referring to FIG. 1, a quickly foldable crib frame shown in FIG. 1 comprises a first U-shaped surrounding frame 1, a second U-shaped surrounding frame 2, first surrounding frame connectors 3, second surrounding frame connectors 4, upper vertical rod connectors 5, upper vertical rods 6, elastic locking protrusions 60, lower vertical rods 7, sliding sleeves 13, rotating bases 8, first bottom horizontal brace rods 9, second bottom horizontal brace rods 12, first bottom horizontal brace linkages 11, second bottom horizontal brace linkages 10, unlocking inserts 130, second locking lugs 71, a sliding sleeve connecting tube 15, a bottom linkage 19, and universal wheels 20.

The first surrounding frame connectors 3 are mounted at the both free ends of the first U-shaped surrounding frame 1. The second surrounding frame connectors 4 are mounted at the both free ends of the second U-shaped surrounding frame 2. The upper vertical rod connectors 5 are mounted at the upper ends of the upper vertical rods 6. Both the first surrounding frame connectors 3 and the second surrounding frame connectors 4 are rotatably connected to the upper vertical rod connectors 5.

The elastic locking protrusion 60 is mounted to the upper vertical rod 6. The lower vertical rod 7 is provided with a plurality of locking holes 70. The elastic locking protrusion 60 is fitted into one of the locking holes 70. When the elastic locking protrusion 60 is pressed, the elastic locking protrusion 60 is separated from the locking hole 70, so that the upper vertical rod 6 slides relative to the lower vertical rod 7, and the upper vertical rod 6 is received in the inner cavity of the lower vertical rod 7.

The rotating bases 8 are mounted at the lower ends of the corresponding lower vertical rods 7, and the first bottom horizontal brace rods 9 and the second bottom horizontal brace rods 12 are rotatably connected to the two sides of the rotating bases 8, respectively.

The sliding sleeve 13 is sleeved on the lower vertical rod 7. One end of the first bottom horizontal brace linkage 11 is rotatably connected to the sliding sleeve 13, and the other end of the first bottom horizontal brace linkage 11 is rotatably connected to the first bottom horizontal brace rod 9. One end of the second bottom horizontal brace linkage 10 is rotatably connected to the sliding sleeve 13, and the other end of the second bottom horizontal brace linkage 10 is rotatably connected to the second bottom horizontal brace rod 12. When the sliding sleeve 13 is sliding relative to the lower vertical rod 7, the first bottom horizontal brace rod 9 and the second bottom horizontal brace rod 12 can be simultaneously driven to rotate relative to the rotating base 8. Two upper vertical rods 6, two lower vertical rods 7, two sliding sleeves 13, and two rotating bases 8 are provided and correspond to each other, respectively. The first bottom horizontal brace rod 9 and the second bottom horizontal brace rod 12 are rotatably connected to each of the rotating bases 8. Each of the first bottom horizontal brace rods 9 is correspondingly connected with one of the first bottom horizontal brace linkages 11, and each of the second bottom horizontal brace rods 12 is correspondingly connected with one of the second bottom horizontal brace linkages 10.

Furthermore, each of the first bottom horizontal brace rods 9 is equipped with one of the universal wheels 20, and each of the second bottom horizontal brace rods 12 is equipped with one of the universal wheels 20.

The two ends of the bottom linkage 19 are respectively connected to the two rotating bases 8 to enhance stability.

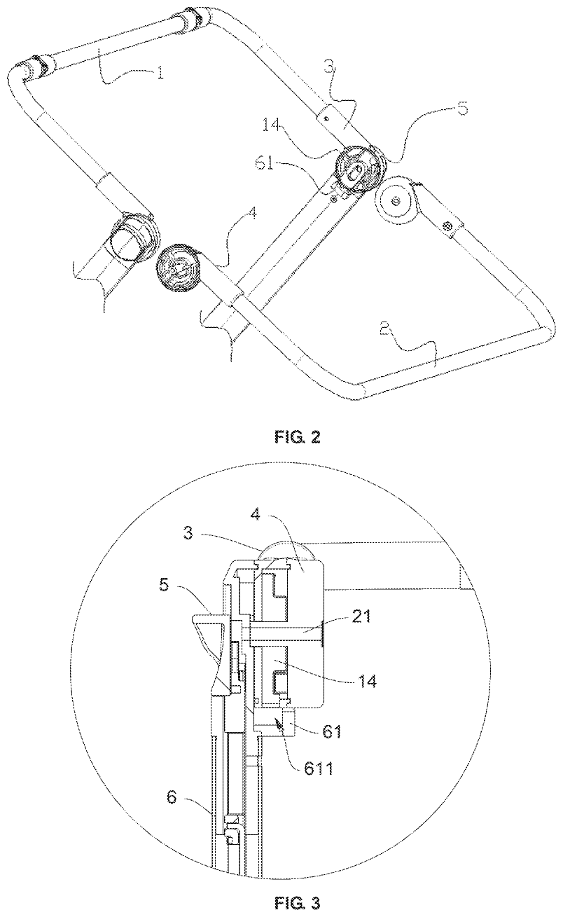

The two ends of the sliding sleeve connecting tube 15 are connected to the two sliding sleeves 13, respectively. When the sliding sleeves 13 are sliding relative to the lower vertical rods 7, the sliding sleeve connecting tube 15 can be moved up and down along with the sliding sleeves 13. Referring to FIG. 2, the first surrounding frame connector 3 and the second surrounding frame connector 4 can be separated from each other for easy mounting and replacement thereof. The plug-in lock block 14 is separably fitted to the first locking lug 61. When the plug-in lock block 14 is locked by the first locking lug 61, the first surrounding frame connector 3 and the second surrounding frame connector 4 are not rotatable relative to the upper vertical rod connector 5. When the plug-in lock block 14 is separated from the first locking lug 61, the first surrounding frame connector 3 and the second surrounding frame connector 4 are rotatable relative to the upper vertical rod connector 5.

Referring to FIG. 3, the riveting pins 21 pass simultaneously through the first surrounding frame connectors 3, the second surrounding frame connectors 4, and the upper vertical rod connectors 5, and the first surrounding frame connectors 3 and the second surrounding frame connectors 4 are rotatable relative to the vertical rod connectors to achieve the folding function of the first U-shaped surrounding frame 1 and the second U-shaped surrounding frame 2.

The plug-in lock block 14 is engaged with the first locking lug 61, and the plug-in lock block 14 is locked by the first locking lug 61, so that the first surrounding frame connector 3 and the second surrounding frame connector 4 are not rotatable relative to the upper vertical rod connector 5.

When the plug-in lock block 14 is being separated from the riveting pin 21, the plug-in lock block 14 is moving along the guiding space 611. After they are separated, the first surrounding frame connector 3 and the second surrounding frame connector 4 are rotatable relative to the upper vertical rod connector 5.

Referring to FIG. 4, the two ends of the sliding sleeve connecting tube 15 are connected to the two sliding sleeves 13, respectively. When the sliding sleeves 13 are sliding relative to the lower vertical rods 7, the sliding sleeve connecting tube 15 can be moved up and down along with the sliding sleeves 13.

Both sliding sleeve locking members 17 are slidably inserted in the sliding sleeve connecting tube 15, wherein one of the sliding sleeve locking members 17 abuts against one of the lower vertical rods 7, and the other sliding sleeve locking member 17 abuts against the other lower vertical rod 7.

The gap between the two sliding sleeve locking members 17 provides space for the movements of the two sliding sleeve locking members 17 in the axial direction of the sliding sleeve connecting tube 15.

The sliding sleeve connecting tube 15 is further provided with through holes 170, and the rotating pins 18 pass through the through holes 170 and abut against the sliding sleeve locking members 17. The rotating pins 18 allow the sliding sleeve connecting tube 15 and the sliding sleeve locking members 17 to be fixed relative to each other, so that the sliding sleeves 13 can be fixed to the lower vertical rods 7.

A sliding sleeve unlocking member 16 is rotatably sleeved on the sliding sleeve connecting tube 15, and the inner wall of the sliding sleeve unlocking member 16 abuts against both of the two sliding sleeve locking members 17. When the sliding sleeve unlocking member 16 is rotated, the two sliding sleeve locking members 17 can be driven to move close to or away from each other. The rotating bases 8 are mounted at the lower ends of the two lower vertical rods 7, and the two ends of the bottom linkage 19 are respectively connected to the two rotating bases 8 to enhance stability.

The universal wheels 20 are further mounted at the lower ends of the two lower vertical rods 7 for easy carrying and moving.

The lower vertical rods 7 each are in a tube structure, and the upper vertical rods 6 are slidably inserted into the lower vertical rods 7. The upper vertical rods 6 and lower vertical rods 7 are provided in a same number and correspond to each other. Referring to FIG. 5, the outer wall of the sliding sleeve connecting tube 15 is provided with sliding slots 151 communicating with the inner cavity of the sliding sleeve connecting tube 15. Each of the two sliding sleeve locking members 17 is provided with a sliding protrusion 171 at its end close to the sliding slot 151. The two sliding protrusions 171 are slidably engaged in the sliding slots 151. The sliding slots 151 serve as a guide for the movements of the sliding protrusions 171.

Two sliding slots 151 are provided. The two sliding slots 151 are arranged spaced apart from each other. The two sliding protrusions 171 are engaged in the two sliding slots 151, respectively, so that the two sliding protrusions 171 will not interfere with each other during sliding.

The sliding sleeve unlocking member 16 is slidably sleeved on the sliding sleeve connecting tube 15. The sliding sleeve unlocking member 16 is provided with a first slot segment 161 and a second slot segment 162. The first slot segment 161 and the second slot segment 162 communicate with each other to form a trapezoidal slot.

When the sliding sleeve unlocking member 16 is rotated relative to the sliding sleeve connecting tube 15, the two sliding protrusions 171 are driven to slide from the first slot segment 161 to the second slot segment 162, so that the two sliding sleeve locking members 17 are moved away from each other.

When the sliding sleeve unlocking member 16 is rotated relative to the sliding sleeve connecting tube 15, the two sliding protrusions 171 may also be driven to slide from the second slot segment 162 to the first slot segment 161, so that the two sliding sleeve locking members 17 are moved close to each other.

Referring to FIG. 6, the sliding sleeves 13 are moved upward along the lower vertical rods 7 so that the first bottom horizontal brace rods 9 and the second bottom horizontal brace rods 12 are driven to be rotated relative to the rotating bases 8 to achieve folding.

Referring to FIG. 7, FIG. 7 shows a state where the sliding sleeves 13 are moved upward along the lower vertical rods 7 so that the first bottom horizontal brace rods 9 and the second bottom horizontal brace rods 12 are driven to be rotated relative to the rotating bases 8 and completely folded.

Referring to FIG. 8, FIG. 8 shows a state where the first U-shaped surrounding frame 1 and the second U-shaped surrounding frame 2 are rotated and completely folded.

Finally, it should be noted that the above embodiments are only intended to illustrate the present disclosure and not to limit the technical solutions described in the present disclosure. Therefore, although the present disclosure has been described in detail herein with reference to the various embodiments described above, it should be understood by those of ordinary skill in the art that the present disclosure may still be modified or replaced with equivalents; and any technical solutions and their improvements that do not depart from the spirit and scope of the present disclosure are intended to be included in the scope of the claims of the present disclosure.

### INDUSTRIAL APPLICABILITY

As described above, the present disclosure provides a quickly foldable crib frame. When the first U-shaped surrounding frame and the second U-shaped surrounding frame are rotated relative to the upper vertical rods, the first U-shaped surrounding frame and the second U-shaped surrounding frame can be folded to occupy less space. When the upper vertical rods are moved relative to the lower vertical rods in the length directions of the lower vertical rods, the upper vertical rods and the lower vertical rods can be overlapped with each other, so that less space is occupied by the upper vertical rods and the lower vertical rods as a whole. The quickly foldable crib frame occupies less space and can be carried and moved conveniently after it is folded.

What is claimed is:

1. A quickly foldable crib frame, comprising: a first U-shaped surrounding frame and a second U-shaped surrounding frame, wherein
a first surrounding frame connector and a second surrounding frame connector are integrally formed, and are arranged at each of tail ends on both sides of the first U-shaped surrounding frame and the second U-shaped surrounding frame, respectively,
the first surrounding frame connector and the second surrounding frame connector on each of both sides are rotatably riveted to an upper vertical rod connector, respectively, wherein
the upper vertical rod connector is fixedly sleeved on a top end of an upper vertical rod,
a bottom end of the upper vertical rod is slidably inserted in an inner cavity of a lower vertical rod,
a bottom end of the lower vertical rod is fixedly inserted in a rotating base,
an end of a first bottom horizontal brace rod and an end of a second bottom horizontal brace rod are rotatably riveted to a front side and a rear side of the rotating base, respectively,
a first end of a first bottom horizontal brace linkage and a first end of a second bottom horizontal brace linkage are rotatably riveted to inner walls of the first bottom horizontal brace rod and the second bottom horizontal brace rod, respectively,
a sliding sleeve of sliding sleeves is slidably sleeved on the lower vertical rod, and both a second end of the first bottom horizontal brace linkage and a second end of the second bottom horizontal brace linkage are rotatably riveted to the sliding sleeve.

2. The quickly foldable crib frame according to claim 1, comprising riveting pins and plug-in lock blocks, wherein both the first surrounding frame connector and the second surrounding frame connector are rotatably connected to the upper vertical rod connector by one of the riveting pins, and each of the plug-in lock blocks is separably fitted to the one of the riveting pins to be switched between a first state and a second state;
in the first state, the each of the plug-in lock blocks locks the one of the riveting pins for fixing the first surrounding frame connector, the second surrounding frame connector, and the upper vertical rod connector relative to one another; and
in the second state, the each of the plug-in lock blocks is separated from the one of the riveting pins for allowing such that the first surrounding frame connector and the second surrounding frame connector to be rotatable relative to the upper vertical rod connector.

3. The quickly foldable crib frame according to claim 2, further comprising first locking lugs, wherein each of the first locking lugs is arranged at the top end of the upper vertical rod, the each of the first locking lugs has a guiding space, wherein an end of one of the plug-in lock blocks passes through the guiding space, and the each of the plug-in lock blocks is engaged with one of the first locking lugs and thus locked by the one of the first locking lugs in the first state.

4. The quickly foldable crib frame according to of claim 1, wherein a side wall of the upper vertical rod is provided with an elastic locking protrusion, a side wall of the lower vertical rod is provided with at least one locking hole communicating with the inner cavity of the lower vertical rod, and the elastic locking protrusion is configured to be locked into the at least one locking hole, so as to be switched between a third state and a fourth state;
in the third state, the elastic locking protrusion is fitted into one of the at least one locking hole, wherein the upper vertical rod is fixed relative to the lower vertical rod; and
in the fourth state, the elastic locking protrusion is disengaged from the one of the at least one locking hole, such that wherein the upper vertical rod is slidable in the inner cavity of the lower vertical rod.

5. The quickly foldable crib frame according to claim 4, comprising a plurality of locking holes, wherein the plurality of locking holes are arranged spaced apart from one another in a length direction of the lower vertical rod, and the elastic locking protrusion is configured to be fitted into the plurality of locking holes to change a length of extension of the upper vertical rod from the inner cavity of the lower vertical rod.

6. The quickly foldable crib frame according to claim 1, further comprising a sliding sleeve connecting tube, at least one sliding sleeve locking member, and at least one rotating pin, wherein the sliding sleeve connecting tube has an end connected to the sliding sleeve, and the at least one sliding sleeve locking member is slidably inserted in the sliding sleeve connecting tube, wherein an end of the at least one sliding sleeve locking member is configured to extend from the sliding sleeve connecting tube and pass through the sliding sleeve to abut against the lower vertical rod; and
the sliding sleeve connecting tube is provided with at least one through hole, and the at least one rotating pin passes through the at least one through hole and abuts against the at least one sliding sleeve locking member, wherein the sliding sleeve connecting tube and the at least one sliding sleeve locking member are fixed relative to each other, and the sliding sleeve is fixed to the lower vertical rod.

7. The quickly foldable crib frame according to claim 6, comprising
two lower vertical rods, wherein the two lower vertical rods are arranged spaced apart from each other, and two ends of the sliding sleeve connecting tube are connected to the sliding sleeves sleeved on the two lower vertical rods, respectively; and
two sliding sleeve locking members, wherein the two sliding sleeve locking members are arranged spaced apart from each other in the sliding sleeve connecting tube, a first sliding sleeve locking member of the two sliding sleeve locking members abuts against a first lower vertical rod of the two lower vertical rods, and a second sliding sleeve locking member of the sliding sleeve locking members abuts against a second lower vertical of the lower vertical rods.

8. The quickly foldable crib frame according to claim 7, wherein an outer wall of the sliding sleeve connecting tube is provided with sliding slots communicating with an inner cavity of the sliding sleeve connecting tube, each of the two sliding sleeve locking members is provided, at an end of the each of the two sliding sleeve locking members close to the sliding slots, with a sliding protrusion, and each of two sliding protrusions is slidably engaged in one of the sliding slots, to move the two sliding sleeve locking members close to or away from each other.

9. The quickly foldable crib frame according to claim 8, further comprising a sliding sleeve unlocking member, wherein the sliding sleeve unlocking member is rotatably sleeved on the sliding sleeve connecting tube, the sliding sleeve unlocking member is provided with a first slot segment and a second slot segment, wherein the first slot segment and the second slot segment communicate with each other to form a trapezoidal slot, and the first slot segment and the second slot segment are fitted with the two sliding protrusions at different time, to move the two sliding sleeve locking members close to or away from each other; and
the sliding sleeve unlocking member is configured to drive the two sliding protrusions to slide from the first slot segment to the second slot segment or from the second slot segment to the first slot segment when rotating relative to the sliding sleeve connecting tube.

10. The quickly foldable crib frame according to claim 1, wherein a second locking lug integrally formed is arranged on an inner wall of a top end of the lower vertical rod, an unlocking insert integrally formed is arranged on a side wall of the sliding sleeve, wherein the unlocking insert is separably fitted to the second locking lug.

11. The quickly foldable crib frame according to claim 1, wherein rotating bases on the both sides are connected by a bottom linkage.

12. The quickly foldable crib frame according to claim 1, wherein a universal wheel is rotatably mounted at each of an end of the first bottom horizontal brace rod away from the rotating base and at the end of the second bottom horizontal brace rod away from the rotating base.

13. A quickly foldable crib frame, comprising a first U-shaped surrounding frame, a second U-shaped surrounding frame, upper vertical rods, and lower vertical rods,
wherein two free ends of the first U-shaped surrounding frame and two free ends of the second U-shaped surrounding frame are each rotatably connected to first ends of the upper vertical rods, and second ends of the upper vertical rods are slidably fitted in the lower vertical rods in length directions of the lower vertical rods.

14. The quickly foldable crib frame according to claim 13, further comprising first surrounding frame connectors, second surrounding frame connectors, upper vertical rod connectors, and riveting pins, wherein each of the first surrounding frame connectors is mounted at a free end of the two free ends of the first U-shaped surrounding frame, each of the second surrounding frame connectors is mounted at a free end of the two free ends of the second U-shaped surrounding frame, each of the upper vertical rod connectors is mounted at an upper end of one of the upper vertical rods, and each of the first surrounding frame connectors and corresponding one of the second surrounding frame connectors are rotatably connected to corresponding one of the upper vertical rod connectors by one of the riveting pins.

15. The quickly foldable crib frame according to claim 13, wherein each of the lower vertical rods is in a tube structure, and each of the upper vertical rods is slidably inserted into one of the lower vertical rods.

16. The quickly foldable crib frame according to claim 13, further comprising rotating bases, first bottom horizontal brace rods, and second bottom horizontal brace rods, wherein each of the rotating bases is connected to a lower end of one of the lower vertical rods, and each of the first bottom horizontal brace rods and each of the second bottom horizontal brace rods are rotatably connected to two sides of one of the rotating bases, respectively.

17. The quickly foldable crib frame according to claim 16, further comprising sliding sleeves, first bottom horizontal brace linkages, and second bottom horizontal brace linkages, wherein each of the sliding sleeves is slidably sleeved on one of the lower vertical rods, each of the first bottom horizontal brace linkages has a first end rotatably connected to one of the sliding sleeves and a second end rotatably connected to one of the first bottom horizontal brace rods, and each of the second bottom horizontal brace linkages has a first end rotatably connected to the one of the sliding sleeves and a second end rotatably connected to the one of the second bottom horizontal brace rods.

18. The quickly foldable crib frame according to claim 17, further comprising a sliding sleeve connecting tube, sliding sleeve locking members, and rotating pins, wherein the sliding sleeve connecting tube has an end connected to the one of the sliding sleeves, and each of the sliding sleeve locking members is slidably inserted in the sliding sleeve connecting tube, and one end of each of the sliding sleeve locking members is configured to extend from the sliding sleeve connecting tube and pass through the one of the sliding sleeves to abut against one of the lower vertical rods; and
the sliding sleeve connecting tube is provided with through holes, and each of the rotating pins passes through one of the through holes and abuts against one of the sliding sleeve locking members, wherein the sliding sleeve connecting tube and the one of the sliding sleeve locking members are fixed relative to each other, and each of the sliding sleeves is fixed to the one of the lower vertical rods.

19. The quickly foldable crib frame according to claim 18, comprising two lower vertical rods, wherein the two lower vertical rods are arranged spaced apart from each other, and two ends of the sliding sleeve connecting tube are connected to the sliding sleeves sleeved on the two lower vertical rods, respectively; and
two sliding sleeve locking members, wherein the two sliding sleeve locking members are arranged spaced apart from each other in the sliding sleeve connecting tube, a first sliding sleeve locking member of the two sliding sleeve locking members abuts against a first lower vertical rod of the two lower vertical rods, and a second sliding sleeve locking member of the sliding sleeve locking members abuts against a second lower vertical rod of the two lower vertical rods.

20. The quickly foldable crib frame according to claim 19, wherein an outer wall of the sliding sleeve connecting tube is provided with sliding slots communicating with an inner cavity of the sliding sleeve connecting tube, each of the two sliding sleeve locking members is provided, at an end of the each of the two sliding sleeve locking members close to one of the sliding slots, with a sliding protrusion, and each of two sliding protrusions is slidably engaged in one of the sliding slots;
the quickly foldable crib frame further comprises a sliding sleeve unlocking member, wherein the sliding sleeve unlocking member is rotatably sleeved on the sliding sleeve connecting tube, the sliding sleeve unlocking member is provided with a first slot segment and a second slot segment, wherein the first slot segment and the second slot segment communicate with each other to form a trapezoidal slot, and the first slot segment and the second slot segment are fitted with the two sliding protrusions at different time, and the two sliding sleeve locking members are moved close to or away from each other; and
the sliding sleeve unlocking member is configured to drive the two sliding protrusions to slide from the first slot segment to the second slot segment or from the second slot segment to the first slot segment when rotating relative to the sliding sleeve connecting tube.
